(19) United States
(12) Patent Application Publication
(10) Pub. No.: US 2008/0000336 A1
(43) Pub. Date: Jan. 3, 2008

(54) Cutter for Cutting a Web-like or Sheet-like Metal Material

(75) Inventors: Mika Virtanen, Helsinki (FI); Ari Maenpaa, Jokela (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Pivatic Oy

(21) Appl. No.: 11/770,141

(22) Filed: Jun. 28, 2007

(30) Foreign Application Priority Data
Jun. 29, 2006 (FI) 20065451

(51) Int. Cl. B23D 19/08

(52) U.S. Cl. 83/471.3

(57) ABSTRACT

A cutter for cutting a web-like or sheet-like metal material is provided. The cutter includes a blade pivotable around a horizontal axis to various angular positions, by which the cutter is enabled to perform optionally a cross-cutting operation of the planar metal material or a partial cutting operation of at least one edge thereof.

### CROSS-REFERENCE TO RELATED APPLICATION

The present application claims the benefit of Finnish Application No. 20065451, filed Jun. 29, 2006, which is incorporated herein by reference in its entirety and for all purposes.

### BACKGROUND OF THE INVENTION

### Field of the Invention

The present invention relates to a cutter for cutting a web-like or sheet-like metal material.

### BRIEF SUMMARY OF THE INVENTION

An objective of the invention is to provide a simple cutter solution, which enables the use of a single device for a variety of cutting operations. The cutter of the invention can be an independent device or can be integrated with the rest of a sheet working machine.

In order to achieve this objective, a cutter of the invention is characterized in that the cutter includes a blade pivotable around a horizontal axis to various angular positions, by which the cutter is enabled to perform optionally a cross-cutting operation of the material or a partial cutting operation of at least one edge.

Preferably, the cutter is disposed in connection with the rest of a sheet working machine and one specific application is the integration of a cutter with a sheet working machine such as disclosed in the present Applicant's earlier international patent application WO 02/38300 A1, which includes a push plate (buffer disc) for operating working tools and which push plate is adapted to be combined with a cutter for operating the cutter by way of said push plate.

### BRIEF DESCRIPTION OF THE SEVERAL VIEWS OF THE DRAWING(S)

The invention will now be described more closely with reference to the accompanying drawings, in which:

FIG. 1 shows in a schematic view of one embodiment for a cutter of the invention;

FIG. 1a shows a tool for the cutter of FIG. 1 in various angular positions;

FIG. 2 shows in a schematic plan view a sheet working machine fitted with a cutter of the invention;

FIG. 3 shows the sheet working machine of FIG. 2 in a schematic side view; and

FIG. 4 shows an enlarged detail in the sheet working machine of FIGS. 2 and 3.

### DETAILED DESCRIPTION OF THE INVENTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

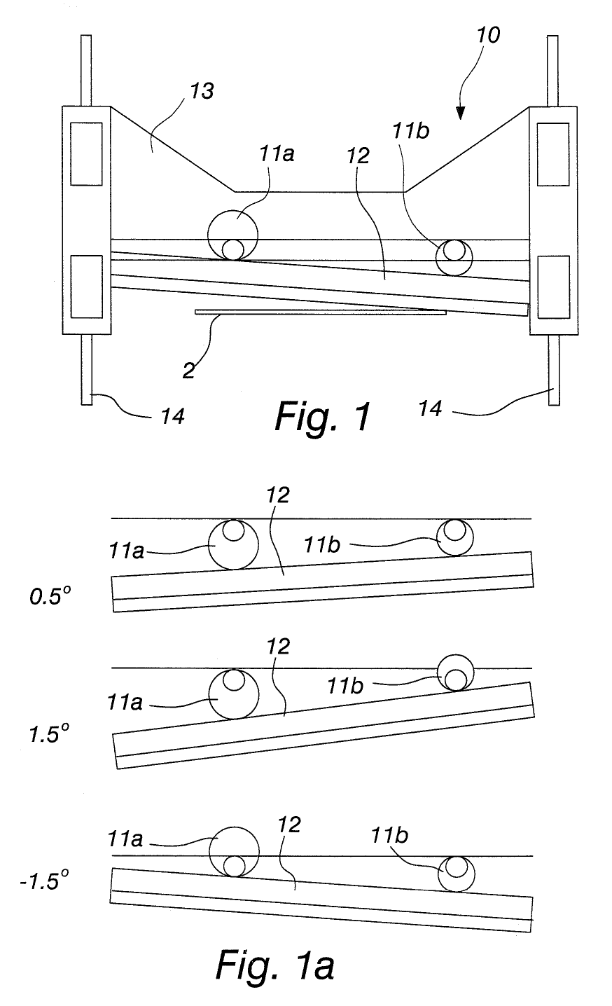

As shown in FIG. 1, a cutter 10 of the invention includes a body element 13, which is adapted to travel along vertical linear tracks 14 for performing a desired cutting operation. The body element 13 is fitted with a blade 12 of the cutter, which is pivotable to a range of angular positions. In the illustrated embodiment, the pivoting of the blade is effected by an eccentric actuator 11a, 11b. In FIG. 1, the cutter blade 12 has been pivoted by the eccentric actuator 11a, 11b to a position which enables performing a partial cutting operation for the right-hand edge of a material 2 to be cut. The turning of what is the left-side eccentric actuator 11a in the embodiment of FIG. 1 to a downturned position results in the cutter blade 12 pivoting to an approximately horizontal angular position which enables a cross-cutting operation of the material 2 to be processed. Turning the eccentric actuator 11a to its downturned position and the eccentric actuator 11b to its upturned position results in the cutter blade 12 pivoting to an angular position which enables a partial cutting operation of the left-hand edge. FIG. 1a shows a schematic illustration about these various angular positions for the cutter blade, the top figure showing an angular position (0.5°) good for cross-cutting, the middle figure showing an angular position (1.5°) enabling a partial cutting operation of the left-hand edge, and the bottom figure showing an angular position (−1.5°) enabling a partial cutting operation of the right-hand edge. These illustrated angular positions are but a few examples of appropriate values and the selection thereof is influenced e.g. by the stroke of a cutter blade and the thickness of a material to be cut.

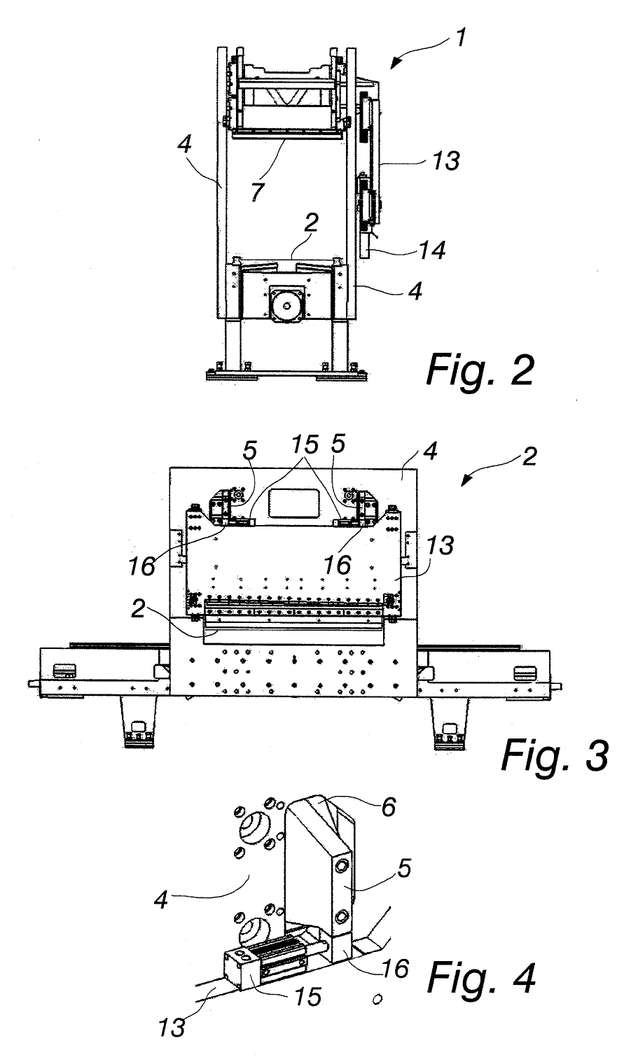

In FIGS. 2 and 3, a cutter of the invention is illustrated as mounted on a sheet working machine 1, which can be a sheet working machine as set forth e.g. in WO 02/38300 A1 for working, especially piercing, notching and shaping a web-like or sheet-like metal material, e.g. steel plate. The discussed sheet working machine includes at least one tool holder (not shown), which is conveniently C-framed having its top member provided with a top tool magazine and its bottom member with a bottom tool magazine, said tool magazines including a top tool and bottom tools, respectively, and said device including a push plate 7 for applying a working force by way of an intermediate body, not shown, to a single top tool. The cutter 10 has its body 13 mounted on an external surface of the sheet working machine's 1 frame 4 for traveling along linear tracks 14 in a vertical motion.

FIG. 4 shows, in an enlarged view, the attachment of the cutter body 13 on a bracket 5 associated with the push plate, said bracket extending through a slot 6 in the sheet working machine's frame 4 and being engaged with the push plate 7 for moving together with the push plate and transmitting a necessary working force to the cutter. The cutter body 13 is provided with an actuator 15, which includes an engagement element 16 displaceable to a position underneath the bracket 5 for activating the cutter to operate through the intermediary of the push plate 7, and said engagement element being disengageable from the bracket 5, whereby the push plate 7 can be used for applying a working force to tools disposed inside the machine frame 4 for performing normal sheet working operations.

Between the cutter body's bottom edge and the sheet working machine's frame 4 are preferably disposed return elements for returning the cutter 3 to a top position after the completion of a working operation. These elements can be e.g. hydraulically operated, pneumatic or spring-loaded.

The eccentric actuators 11a, 11b can be hydraulically operated, pneumatic, or electrically operated. The actuator 15 for the cutter can also be hydraulic, pneumatic, or electrically operated.

In addition, the cutter can be adapted for pivoting around a substantially vertical axis to a range of angular positions relative to a material feeding direction, whereby a cross-cutting operation or a partial edge-cutting operation by means of a blade adapted for pivoting around a horizontal axis can proceed either substantially perpendicularly to the web feeding direction or at an angular position relative thereto.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A cutter for cutting a planar metal material having a cross-direction defined by opposed edges, the cutter including a blade having a length, the blade being pivotable about a first axis disposed perpendicularly to the length of the blade and substantially parallel to the planar metal material, the blade thereby being pivotable to various angular positions with respect to the planar metal material, whereby the blade disposed substantially parallel to the planar metal material allows the cutter to perform a cross-cutting operation in the cross-direction of the planar metal material, and pivoting of the blade about the first axis allows the cutter to perform a partial cutting operation of at least one of the opposing edges of the planar metal material.

2. A cutter according to claim 1, wherein the cutter includes an actuator operably engaged with the blade and configured to pivot the blade about the first axis to a selected angular position with respect to the planar metal material.

3. A cutter according to claim 1, wherein the cutter is operably engaged with a sheet working machine adapted to at least one of work, pierce, notch and shape the planar metal material, said machine comprising a frame, at least one tool holder disposed inside the frame and configured to receive a working tool, and a push plate operably engaged with and movable by a drive element, the push plate being configured to apply a working force to the working tool to generate a working motion therefor, the cutter being disposed outside the machine frame and operably engaged with the push plate so as to move in conjunction therewith as the push plate applies said working force and generates said working motion for the working tool.

4. A cutter according to claim 3, wherein the cutter includes a body configured to travel in a substantially vertical direction along linear tracks disposed on the machine frame, on an external surface of the frame.

5. A cutter according to claim 3, wherein the push plate includes at least one bracket extending outside the frame, and wherein the cutter includes an actuator, the actuator being engageable with the bracket for operating the cutter and disengageable from the bracket for allowing the sheet working machine to perform a working operation using a working tool disposed inside the frame, without operating the cutter.

6. A cutter according to claim 1, wherein the cutter is further configured to pivot about a second axis, the second axis being disposed substantially perpendicularly to the planar metal material.
